(19) United States
(12) Patent Application Publication
(10) Pub. No.: US 2015/0277605 A1
(43) Pub. Date: Oct. 1, 2015

(54) TOUCH SCREEN PANEL AND METHOD OF FABRICATING THE SAME

(71) Applicants: Samsung Display Co., Ltd., Yongin-City (KR); DONGWOO FINE-CHEM CO., LTD., Iksan-Si (KR)

(72) Inventors: Soo-Min AN, Yongin-City (KR); Young-Jin YOON, Iksan-Si (KR); Soo-Guy RHO, Yongin-City (KR); Sang-Duck PARK, Yongin-City (KR); Kang-Bin YI, Yongin-City (KR); Jung-Bo LEE, Yongin-City (KR); Sang-Hun CHO, Yongin-City (KR); Gi-Yong NAM, Iksan-Si (KR); Young-Joon CHIN, Iksan-Si (KR); Sang-Tae KIM, Iksan-Si (KR); Yong-Seok CHOI, Iksan-Si (KR)

(21) Appl. No.: 14/622,100

(22) Filed: Feb. 13, 2015

(30) Foreign Application Priority Data
Mar. 26, 2014 (KR) 10-2014-0035295

(51) Int. Cl. G06F 3/041

(52) U.S. Cl. CPC G06F 3/041

(57) ABSTRACT

Disclosed is a touch screen panel, including: a glass substrate including an active area and a non-active area; enhancement layers formed on upper and lower surfaces of the glass substrate; sensing patterns disposed on a surface of one of the enhancement layers in the active area; and sensing lines disposed in the non-active area, and electrically connected with the sensing patterns. Here, a side surface of the glass substrate may include a plurality of blunt areas depressed in a shape of a curved surface.

### CROSS-REFERENCE TO RELATED APPLICATION

This application claims priority to and the benefit of Korean Patent Application No. 10-2014-0035295, filed on Mar. 26, 2014, in the Korean Intellectual Property Office, the entire contents of which are incorporated herein by reference in their entirety.

### BACKGROUND

1. Field

The present application relates to a touch screen panel and a method of fabricating the same, and more particularly, to a touch screen panel with an improved elongation rate, and a method of fabricating the same.

2. Description of the Related Art

A touch screen panel is an input device enabling a user to input a command by selecting instruction contents displayed on a screen of a display device, and the like by a finger of the user or an object.

In general, a window is provided on an upper surface of the touch screen panel to improve mechanical strength of the touch screen panel.

The window is generally a strengthened glass substrate. The window is fabricated by cutting an organic glass substrate by a cell unit, and then individually performing a strengthening process on the cut organic substrate. The fabrication of the touch screen panel by using the window in the cell unit has a disadvantage in that it is impossible to secure mass productivity.

However, when the touch screen panel is fabricated by using a non-strengthened glass substrate as the window, breaking strength of the window is weak, so that the non-strengthened glass substrate cannot serve as the window.

### SUMMARY

Embodiments have been made in an effort to provide a touch screen panel with improved breaking strength and an improved elongation rate.

Further, embodiments been made in an effort to provide a method of fabricating the touch screen panel.

An exemplary embodiment provides a touch screen panel, comprising: a glass substrate including an active area and a non-active area; enhancement layers disposed on upper and lower surfaces of the glass substrate; sensing patterns disposed on a surface of one of the enhancement layers in the active area; and sensing lines disposed in the non-active area, and electrically connected to the sensing patterns. Here, a side surface of the glass substrate may include a plurality of blunt areas depressed in a shape of a curved surface.

An elongation rate of the glass substrate may be 1% or more.

A size of the blunt areas disposed on the side surface of the glass substrate may be 6 μm or more, and more preferably, 6 μm to 12 μm.

Another exemplary embodiment provides a method of fabricating a touch screen panel, including: forming enhancement layers by performing a strengthening process on upper and lower surfaces of a glass substrate; forming touch screen units for a cell unit area on one of the upper or lower surfaces of the glass substrate on which the enhancement layer is formed; fabricating a pre touch screen panel by cutting the glass substrate, on which the touch screen units are formed, for each cell unit area; forming passivation layers on upper and lower surfaces of the pre touch screen panel; and performing a healing process of forming a plurality of blunt areas, which are depressed in a shape of a curved surface by making a healing composition be in contact with a side surface of the pre touch screen panel. Herein, the healing composition may include water, 1 wt % to 20 wt % of hydrofluoric acid, 0.1 wt % to 5 wt % of ammonium fluoride, and 1 wt % to 20 wt % of mineral acid.

The mineral acid may be at least one of nitric acid, sulfuric acid, hydrochloric acid, phosphoric acid, and carbonic acid.

The passivation layers may have a form of a detachable film or a paste.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a top plan view schematically illustrating a touch screen panel according to an exemplary embodiment.

FIG. 2 is an enlarged diagram illustrating a main part in an example of a sensing pattern illustrated in FIG. 1.

FIG. 3 is a cross-sectional view taken along line I-I′ of FIG. 2.

FIG. 4 is an enlarged view of region B of FIG. 3.

FIGS. 5A, 5B, 5C, 5D, 5E, 5F are process cross-sectional views illustrating a method of fabricating the touch screen panel illustrated in FIGS. 1 to 4.

FIG. 6 is an enlarged view of region C of FIG. 5F.

FIG. 7 is a graph illustrating a size of a blunt region and an elongation rate according to a healing time.

FIGS. 8, 9, 10 are SEM pictures of a surface of a glass substrate according to Comparative Examples 1, 3, and 7 of Table 1.

FIGS. 11 and 12 are SEM pictures of a surface of a glass substrate according to Experimental Examples 1 and 2 of Table 1.

FIG. 13 is a graph illustrating an elongation rate according to a size of the blunt region.

### DETAILED DESCRIPTION

The inventive concept may be variously modified and have various forms, so that specific embodiments will be illustrated in the drawings and described in the detailed description. However it should be understood that the inventive concept is not limited to the specific embodiments, but includes all changes, equivalents, or alternatives which are included in the spirit and technical scope of the inventive concept.

Like reference numerals designate like elements throughout the specification. In the accompanying drawings, sizes of structures are illustrated to be enlarged compared to actual sizes for clarity. Terms “first”, “second”, and the like may be used for describing various constituent elements, but the constituent elements should not be limited to the terms. The terms are used only to discriminate one constituent element from another constituent element. For example, a first element could be termed a second element, and similarly, a second element could be also termed a first element without departing from the scope of the present disclosure. As used herein, the singular forms are intended to include the plural forms as well, unless the context clearly indicates otherwise.

It should be understood that terms “include” or “have” indicates that a feature, a number, a step, an operation, a component, a part or the combination thereof described in the specification is present, but do not exclude a possibility of presence or addition of one or more other features, numbers, steps, operations, components, parts or combinations, in advance. It will be understood that when an element such as a layer, film, region, or substrate is referred to as being “on” another element, it can be directly on the other element or intervening elements may also be present. On the contrary, it will be understood that when an element such as a layer, film, region, or substrate is referred to as being “beneath” another element, it can be directly beneath the other element or intervening elements may also be present.

Hereinafter, an exemplary embodiment will be described in more detail with reference to the accompanying drawings.

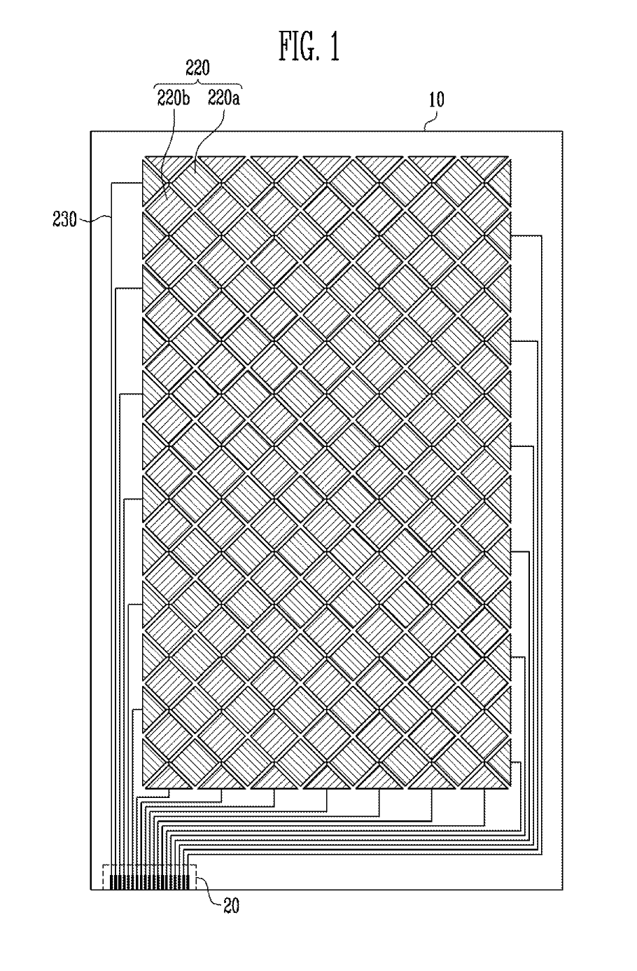

FIG. 1 is a top plan view schematically illustrating a touch screen panel according to an exemplary embodiment, and FIG. 2 is an enlarged diagram illustrating a main part in an example of a sensing pattern illustrated in FIG. 1.

Referring to FIGS. 1 and 2, the touch screen panel may include a glass substrate 10, sensing patterns 220 disposed on the glass substrate 10, and sensing lines 230 for connecting the sensing patterns 220 and an external driving circuit (not illustrated) through a pad part 20.

The sensing patterns 220 may include first sensing cells 220a formed to be connected in a row direction for each row line, first connection lines 220a1 for connecting the first sensing cells 220a in the row direction, second sensing cells 220b formed to be connected in a column direction for each column line, and second connection lines 220b1 for connecting the second sensing cells 220b in the column direction.

The first sensing cells 220a and the second sensing cells 220b may be alternately disposed so as not to overlap each other. Further, the first connection lines 220a1 and the second connection lines 220b1 may cross each other. Here, an insulation layer (not illustrated) may be disposed between the first connection lines 220a1 and the second connection lines 220b1. Further, the insulation layer may insulate the first connection lines 220a1 and the second connection lines 220b1.

In the meantime, the first sensing cells 220a and the second sensing cells 220b may include a transparent conductive material, for example, an Indium Tin Oxide (ITO), and may be integrally formed with the first connection lines 220a1 and the second connection lines 220b1. Further, the first sensing cells 220a and the second sensing cells 220b may be separately formed with the first connection lines 220a1 and the second connection lines 220b1 to be electrically connected with each other.

For example, the second sensing cells 220b may be formed to be integrally patterned with the second connection line 220b1 in the column direction. The first sensing cells 220a may be patterned to have an independent pattern between the second sensing cells 220b, and may be connected in the row direction by the first connection lines 220a1.

Here, the first connection lines 220a1 may be connected while being in direct contact with the first sensing cells 220a on or under the first sensing cells 220a. Further, the first connection lines 220a1 may be electrically connected with the first sensing cells 220a through contact holes.

The first connection lines 220a may include a transparent conductive material, such as an ITO, or an opaque low-resistance material. The opaque low-resistance material is at least on of Ag, Al, Cu, Cr, Ni, Mo, and Ti. Further, when the first connection lines 220a1 include an opaque low-resistance material, widths of the first connection lines 220a1 and the like may be adjusted so as not to be observed with the eyes of a user.

The sensing lines 230 may be electrically connected with the first sensing cells 220a and the second sensing cells 220b in a row line unit and a column line unit, respectively. Accordingly, the sensing lines 230 may electrically connect the first sensing cells 220a and the second sensing cells 220b and an external driving circuit (not illustrated), such as a location detection circuit, through the pad part 20.

The sensing lines 230 may be disposed at an outer side of an active area in which an image is displayed. The sensing lines 230 may include one of low resistance materials, for example, molybdenum (Mo), silver (Ag), titanium (Ti), copper (Cu), aluminum (Al), and molybdenum/aluminum/molybdenum (Mo/Al/Mo). Further, the sensing lines 230 may also include the same material as that of the sensing patterns 220.

The touch screen panel is a capacitive touch panel, and when the touch screen panel is in contact with a hand of a person or a contact object, such as a stylus pen, the touch screen panel transmits a change in capacitance according to a contact position to a driving circuit (not illustrated) from the sensing patterns 220 through the sensing line and the pad part 20. Then, the change in the capacitance is converted into an electrical signal by an X and Y input processing circuit (not illustrated) and the like, so that the contact position may be recognized.

The touch screen panel may be generally formed on an independent substrate and attached onto an upper surface of a display device and the like. However, in this case, a thickness of the display device may be increased.

Accordingly, in the exemplary embodiment, an upper surface of the glass substrate 10 is a surface with which the contact object is in direct contact, and the glass substrate 10 may serve as a window of the display device.

That is, in one embodiment, the glass substrate and the window of the touch screen panel are integrally implemented without adopting a separate window glass. Accordingly, it is possible to implement a thin touch screen panel, and improve fabrication efficiency by simplifying a fabrication process, reducing material cost, and the like.

However, to this end, the glass substrate 10 may be a strengthened glass substrate in order to serve as the window. Accordingly, in the present exemplary embodiment, the strengthening process is not performed on each cell unit, but is performed on a mother substrate before the cutting in the cell unit, thereby achieving a great advantage in securing mass productivity.

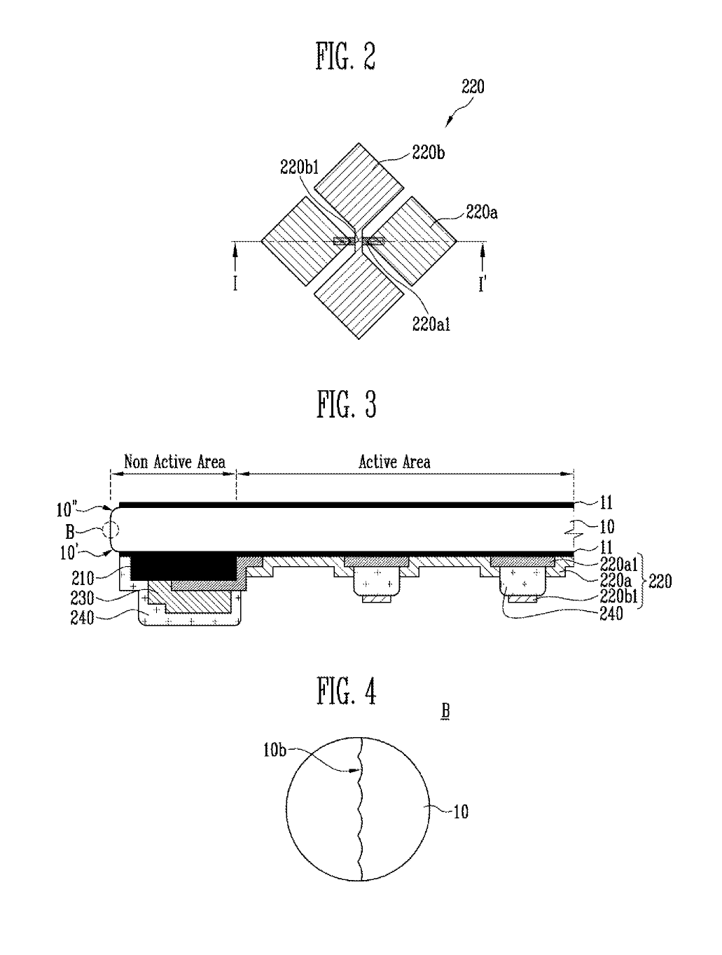

FIG. 3 is a cross-sectional view taken along line I-I′ of FIG. 2, and FIG. 4 is an enlarged view of region B of FIG. 3.

Referring to FIGS. 3 and 4, the glass substrate 10 in the mother substrate state may be the strengthened glass substrate. Here, the strengthened glass substrate may be manufactured by a process of, for example, dipping the glass substrate into KNO₃ solution, and then heating the solution at a temperature of 400° C. to 450° C. for about 15 to 18 hours. A sodium (Na) ingredient existing on the surface of the glass substrate is substituted to a potassium (K) ingredient through the aforementioned process, thereby improving strength of the surface of the glass substrate.

That is, as illustrated in FIG. 3, the sodium (Na) ingredient existing on the surface of the glass substrate is substituted to the potassium (K) ingredient, so that strength of an enhancement layer 11 formed on the surface of the glass substrate 10, on which the strengthening and tempering is performed, is improved.

Further, the sensing patterns 220 formed on an active area of the strengthened glass substrate include the first sensing cells 220a formed to be connected in a first direction for each row line, the first connection lines 220a1 for connecting the first sensing cells 220a in the row direction, the second sensing cells 220b formed to be connected in the column direction for each column line, and the second connection lines 220b1 for connecting the second sensing cells 220b in the column direction, and an insulating layer 240 is interposed at crossing portions of the first connection lines 220a1 and the second connection lines 220b1.

Further, a black matrix 210, and the sensing lines 230 formed to overlap the black matrix 210 and electrically connected with the sensing patterns 220 are disposed in a non-active area positioned at an outer side of the active area as illustrated in FIG. 3.

In this case, the black matrix 210 serves to prevent the pattern of the sensing line and the line formed in the non-active area from being viewed, and configure a border of the display area.

However, thicknesses and areas of the sensing patterns 220, the insulating layer 240, the black matrix 210, and the sensing lines 230 illustrated in FIG. 3 are enlarged for illustration for convenience of the description, and are formed to be considerably smaller than an actual thickness of the glass substrate 10.

However, in the case where the glass substrate in the strengthened mother substrate state is cut in the cell unit, the cut cross section, that is the cutting plane of the glass substrate, may be in a non-strengthened state. Accordingly, in the present exemplary embodiment, micro cracks formed on the cutting plane are removed by performing a healing process on the exposed cutting plane. Accordingly, it is possible to secure mass productivity of the touch screen panel, and improve breaking strength and an elongation rate of the glass substrate.

As illustrated in FIG. 3, the healing process is performed on the cutting plane of the glass substrate 10 according to the present exemplary embodiment, so that an edge portion 10′ may be implemented in a gentle shape.

Further, the cutting plane of the glass substrate 10 may include a plurality of blunt areas 10b. The blunt areas 10b are areas in which the micro cracks are removed, and may be regions in which the micro cracks are isotropically etched to be depressed in a curved surface shape. Here, the blunt areas 10b may have a size of 6 μm or more. The blunt areas 10b may preferably have a size of 6 μm to 12 μm.

Further, an elongation rate of the glass substrate 10 may be increased by the plurality of blunt areas 10b. The glass substrate 10 in the touch screen panel may have an elongation rate of 1% or more. This is because stress is concentrated to the micro cracks by elongation during the elongation of the glass substrate, so that the micro cracks cause damage of the glass substrate, but the blunt areas 10b, sometimes called the blunt regions 10b, prevent stress by the elongation from being concentrated to a specific region.

Accordingly, as the sizes of the blunt areas 10b are increased, reliability of the glass substrate 10 may be improved.

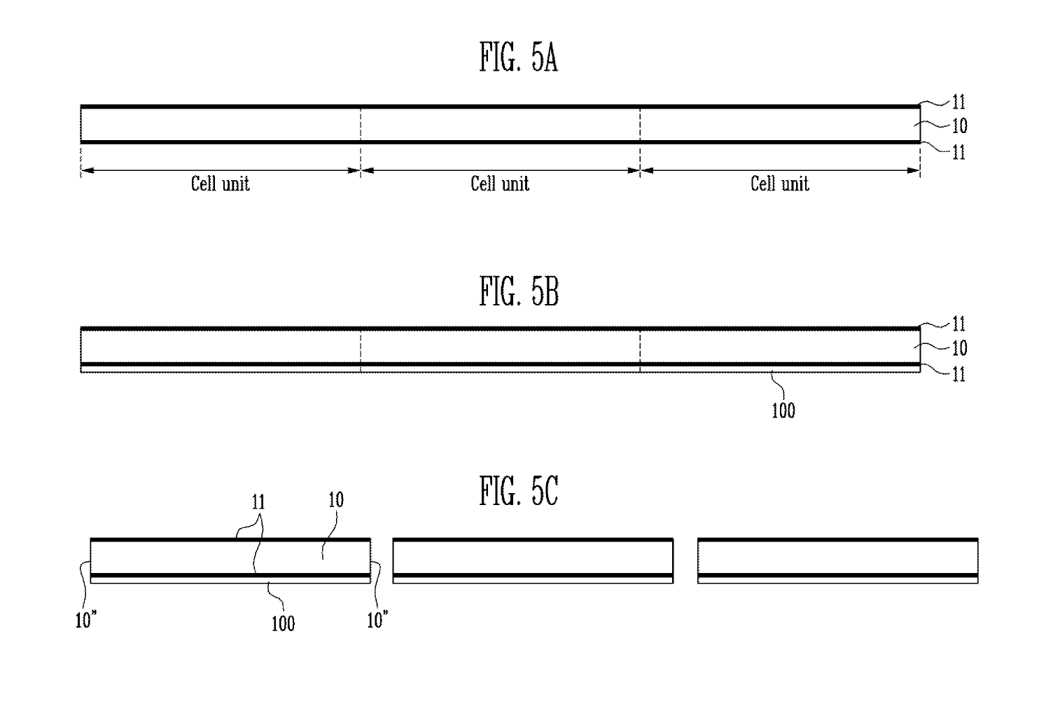

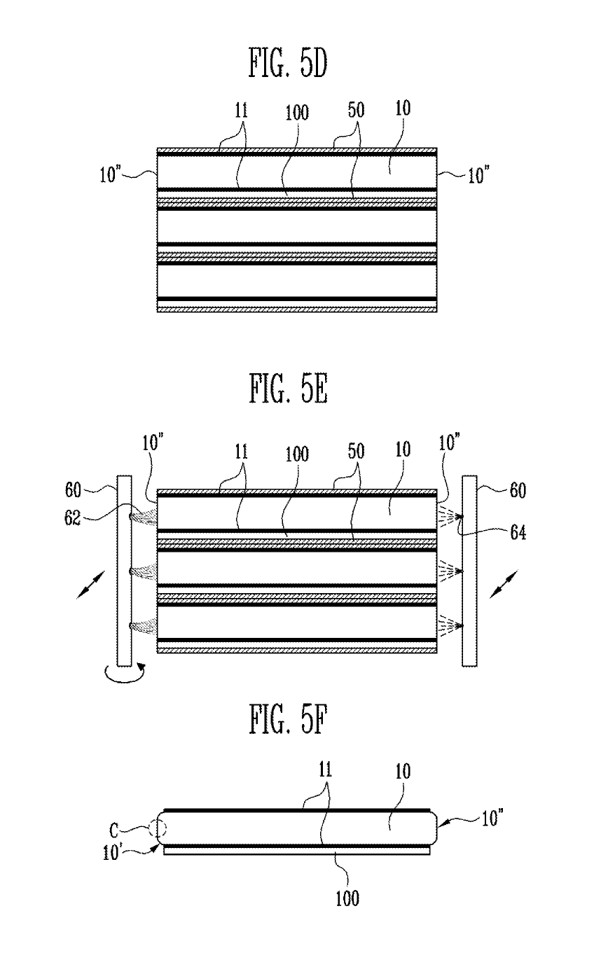

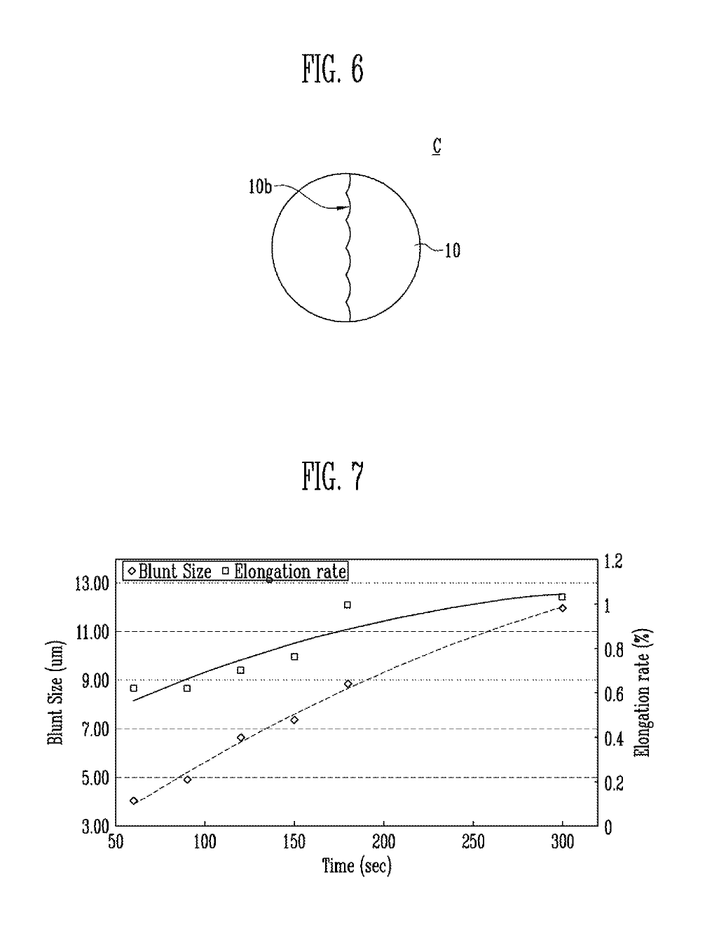

FIGS. 5A to SF are process cross-sectional views illustrating a method of fabricating the touch screen panel illustrated in FIGS. 1 to 4, FIG. 6 is an enlarged view of region C of FIG. 5F, and FIG. 7 is a graph illustrating a size of a blunt region and an elongation rate according to a healing time.

First, referring to FIG. 5A, a strengthening process is performed on an entire surface of the glass substrate 10 in the mother substrate state, that is, the glass substrate 10, on which a plurality of touch screen panels is to be formed in a cell unit.

The strengthening process may be performed by a process of dipping the glass substrate 10 into KNO₃ solution, and then heating the solution at a temperature of 400° C. to 450° C. for about 15 to 18 hours, and a sodium (Na) ingredient existing on the surface of the glass substrate is substituted to a potassium (K) ingredient through the aforementioned process, thereby improving strength of the surface of the glass substrate. That is, after the performance of the strengthening process, the enhancement layer 11 is formed on the surface of the glass substrate 10. However, this is one exemplary embodiment, and the strengthening process for the glass substrate 10 is not limited thereto.

Referring to FIG. 5B, a touch screen unit 100 is formed for each cell unit area of the glass substrate. In the meantime, in the present exemplary embodiment, it is described that the touch screen unit 100 is formed on the glass substrate 10 in a three cell unit, but are not limited thereto.

Further, as illustrated in FIGS. 1 to 4, the touch screen unit 100 may include the sensing patterns 220 formed in the active area, the black matrix 210 and the sensing lines 230 formed in the non-active area.

Referring to FIG. 5C, when the touch screen unit 100 is formed for each cell unit area on the glass substrate 10, pre touch screen panels are formed by cutting the touch screen unit 100 in each cell unit area. Here, a method of forming the pre touch screen panel may include a physical or chemical cutting method by using, for example, a wheel, laser, water-jet, and etching. Further, after the cutting is completed, polishing may be further performed on the cutting plane.

In the meantime, a cutting plane 10″ of the glass substrate 10 may be exposed to the outside. Further, the cutting plane 10″ of the glass substrate 10 may be an exposed surface on which the strengthening process is not performed. Further, micro cracks may exist on the cutting plane 10″ of the glass substrate 10. The micro cracks may be a reason of the damage of the glass substrate 10, and may cause deterioration of reliability of the touch screen panel.

Accordingly, a healing process needs to be performed on the cutting plane 10″.

Referring to FIG. 5D, passivation layers 50 are formed on upper and lower surfaces of the pre touch screen panels. The passivation layers 50 may have a film or paste form, and may be detachable from the pre touch screen panel. Further, the passivation layers 50 may prevent immersion of a chemical solution used in the healing process, which is to be performed later.

After the forming of the passivation layers 50, the pre touch screen panels are stacked.

Referring to FIGS. SE and SF, after the pre touch screen panels are stacked, the healing process is performed.

The healing process may be performed by injecting a healing composition to the cutting plane 10″ through an injection nozzle 64 of a solution discharge device 60. Further, a roll brush 62 provided at one side of the solution discharge device 60 makes the healing composition be uniformly in contact with the cutting plane 10″.

The healing composition may include water, 1 wt % to 20 wt % of hydrofluoric acid, 0.1 wt % to 5 wt % of ammonium fluoride, and 1 wt % to 20 wt %/a of mineral acid. Here, the mineral acid may be at least one of nitric acid, sulfuric acid, hydrochloric acid, phosphoric acid, and carbonic acid.

The healing composition has an isotropic etching property, and may be in contact with the cutting plane 10″ of the glass substrate 10 to remove the micro cracks. The area, which previously includes the micro cracks, may be the blunt areas 10b by the healing composition.

The blunt areas 10b may be areas having a recess shape formed by isotropically etching the area, which previously includes the micro cracks, with the healing composition. That is, the blunt areas 10b may be areas depressed in a curved surface shape.

Sizes of the blunt areas 10b may be increased according to an increase in a performance hour, e.g., the time of performance, of the healing process as illustrated in FIG. 6. Further, an elongation rate of the glass substrate 10 may be increased according to an increase in a performance hour of the healing process as illustrated in FIG. 6.

Here, the sizes of the blunt areas 10b may be 6 μm or more. The blunt areas may preferably have a size of 6 μm to 12 μm.

Further, an elongation rate of the glass substrate 10 may be increased by the plurality of blunt areas 10b. The glass substrate 10 in the touch screen panel may have an elongation rate of 1% or more. This is because stress is concentrated to the micro crack by elongation during the elongation of the glass substrate, so that the micro crack causes damage of the glass substrate, but the blunt regions 10b prevent stress by the elongation from being concentrated to a specific region.

Accordingly, as the sizes of the blunt areas 10b are increased, reliability of the glass substrate 10 may be improved.

After the healing process is performed, the passivation layers 50 are removed from the pre touch screen panels and a cleaning process is performed to fabricate the touch screen panels.

Table 1 below is a table for describing a size of the blunt area and an elongation rate of the glass substrate 10 according to a composition of the healing composition used in the healing process.

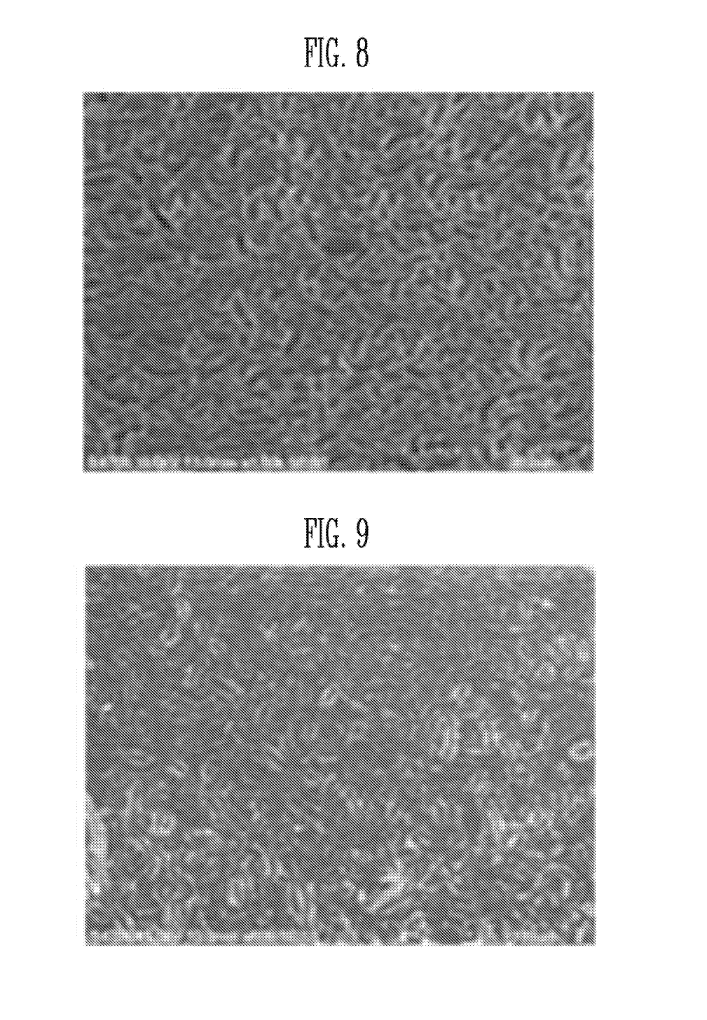

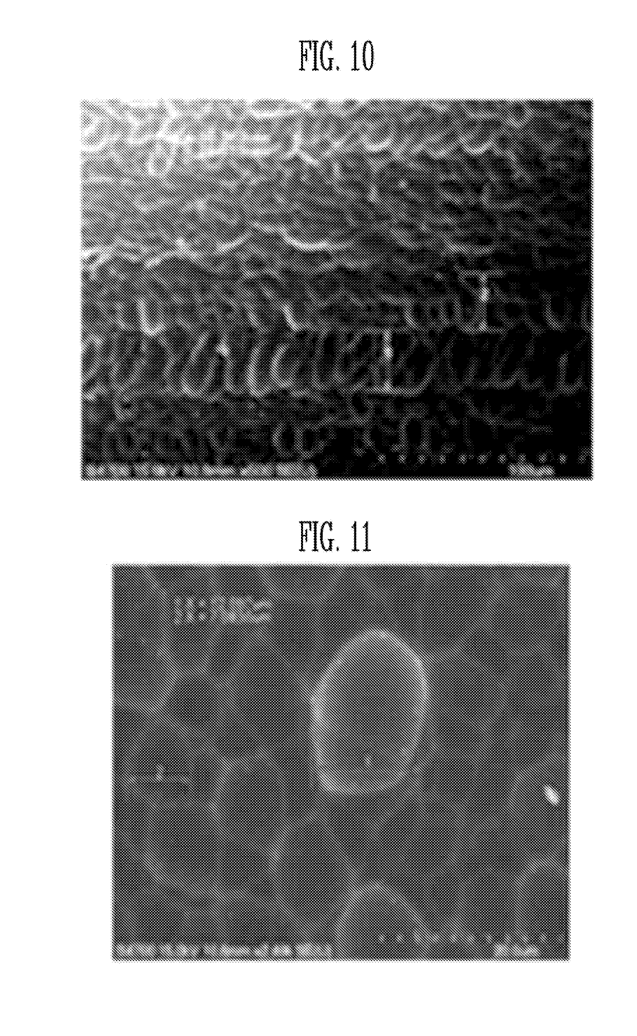

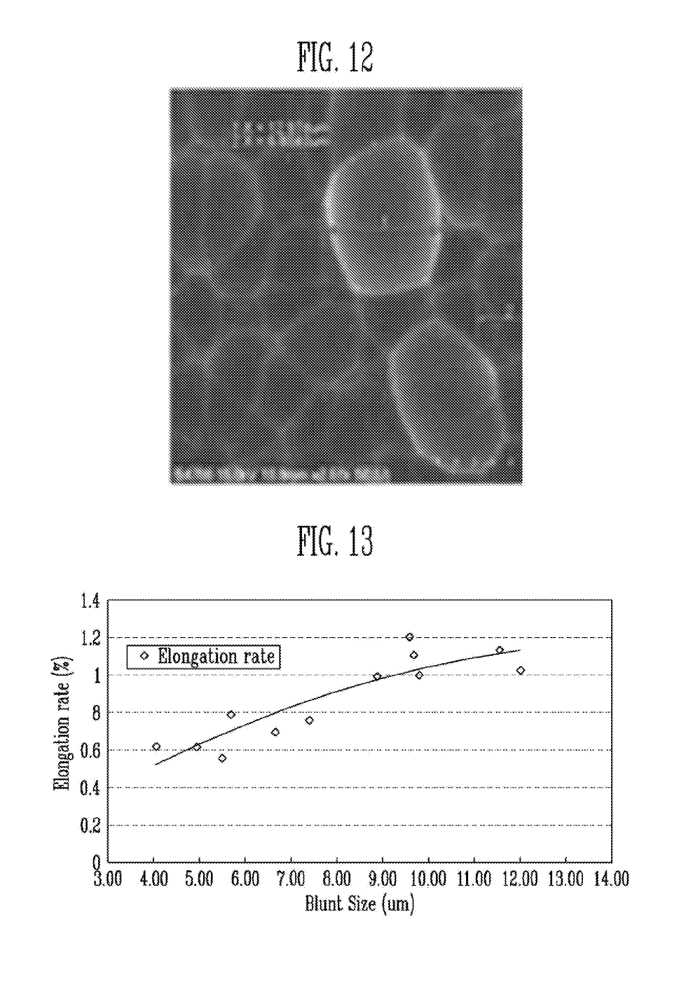

FIGS. 8 to 10 are SEM pictures of a surface of a glass substrate according to Comparative Examples 1, 3, and 7 of Table 1, FIGS. 11 and 12 are SEM pictures of a surface of a glass substrate according to Experimental Examples 1 and 2 of Table 1, and FIG. 13 is a graph illustrating an elongation rate according to a size of the blunt region.

Herein, a temperature of the healing composition used in Experimental Examples 1 to 6, and Comparative Examples 1 to 7 is a constant temperature (25° C.), and a healing process performing time is three minutes.

TABLE 1
Size and elongation rate of the blunt area according to a composition of
the healing composition

| | | | | Size of | |
|---|---|---|---|---|---|
| | | Ammonium | Nitric | blunt | Elongation |
| | Hydrofluoric | chloride | acid | area | rate |
| | acid (wt %) | (wt %) | (wt %) | (μm) | (%) |
| Experimental | 7 | 0.5 | 7 | 9.5 | 1.12 |
| Example 1 | | | | | |
| Experimental | 7 | 0.5 | 6 | 9.3 | 1.02 |
| Example 2 | | | | | |
| Experimental | 7 | 0.7 | 7 | 9.3 | 1.02 |
| Example 3 | | | | | |
| Experimental | 7 | 0.7 | 6 | 9.1 | 1.00 |
| Example 4 | | | | | |
| Experimental | 7 | 1 | 7 | 9.1 | 1.01 |
| Example 5 | | | | | |
| Experimental | 7 | 1 | 20 | 10.5 | 1.10 |
| Example 6 | | | | | |
| Comparative | 1 | — | — | 1.20 | 0.41 |
| Example 1 | | | | | |
| Comparative | 5 | — | — | 1.85 | 0.50 |
| Example 2 | | | | | |
| Comparative | 7 | — | — | 3.5 | 0.61 |
| Example 3 | | | | | |
| Comparative | 7 | 1 | — | 3.4 | 0.58 |
| Example 4 | | | | | |
| Comparative | 7 | 3 | — | 3.3 | 0.56 |
| Example 5 | | | | | |
| Comparative | 4 | — | 4 | 2.0 | 0.52 |
| Example 6 | | | | | |
| Comparative | 7 | 1 | 0.1 | 3.8 | 0.62 |
| Example 7 | | | | | |

Referring to Table 1, and FIGS. 8 to 13, in Comparative Examples 1 to 7, it can be seen that the size of the blunt area is less than 6 μm, and the elongation rate of the glass substrate 10 is lower than 1%. The reason is that, as illustrated in FIGS. 8 to 10, the size of the blunt area is not sufficient, so that stress by the elongation may be locally concentrated.

In the meantime, in Experimental Examples 1 to 6, it can be seen that the size of the blunt area is equal to or greater than 9 μm, and the elongation rate of the glass substrate 10 is equal to or greater than 1%. The reason is that, as illustrated in FIGS. 11 and 12, the size of the blunt area is relatively greater than those of Comparative Examples 1 to 7, and the stress by the elongation is not concentrated in one area as the size of the blunt area is increased.

Further, in Comparative Examples 1 to 7, and Experimental Examples 1 to 6, it can be seen that as the size of the blunt area is increased, the elongation rate is increased.

By way of summation and review, the aforementioned touch screen panel may be an integrated touch screen panel in which detection electrodes are formed on the window glass substrate. Further, according to the method of fabricating the touch screen panel, the window glass substrate is subject to the strengthening process, so that a side surface of the glass substrate exposed by the cutting may be subject to the healing processed. Accordingly, it is possible to improve breaking strength and an elongation rate of the glass substrate of the touch screen panel.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the inventive concept as set forth in the following claims.

What is claimed is:

1. A touch screen panel, comprising:
a glass substrate including an active area and a non-active area;
enhancement layers disposed on upper and lower surfaces of the glass substrate;
sensing patterns disposed on a surface of one of the enhancement layers in the active area; and
sensing lines disposed in the non-active area, and electrically connected to the sensing patterns,
wherein a side surface of the glass substrate includes a plurality of blunt areas depressed in a shape of a curved surface.

2. The touch screen panel of claim 1, wherein an elongation rate of the glass substrate is 1% or more.

3. The touch screen panel of claim 2, wherein a size of the blunt areas disposed on the side surface of the glass substrate is 6 μm or more.

4. The touch screen panel of claim 3, wherein the size of the blunt areas is 6 μm to 12 μm.

5. A method of fabricating a touch screen panel, comprising:
forming enhancement layers by performing a strengthening process on upper and lower surfaces of a glass substrate;
forming touch screen units for a cell unit area on one of the upper or lower surfaces of the glass substrate on which the enhancement layer is formed;
fabricating a pre touch screen panel by cutting the glass substrate, on which the touch screen units are formed, for each cell unit area;
forming passivation layers on upper and lower surfaces of the pre touch screen panel; and
performing a healing process of forming a plurality of blunt areas, which are depressed in a shape of a curved surface by making a healing composition be in contact with a side surface of the pre touch screen panel,
wherein the healing composition includes water, 1 wt % to 20 wt % of hydrofluoric acid, 0.1 wt % to 5 wt % of ammonium fluoride, and 1 wt % to 20 wt % of mineral acid.

6. The method of claim 5, wherein the mineral acid is at least one of nitric acid, sulfuric acid, hydrochloric acid, phosphoric acid, and carbonic acid.

7. The method of claim 5, wherein the glass substrate has an elongation rate of 1% or more by the healing process.

8. The method of claim 7, wherein a size of the blunt areas is 6 μm or more.

9. The method of claim 8, wherein the size of the blunt areas is 6 μm to 12 μm.

10. The method of claim 5, wherein the passivation layers have a form of a detachable film or a paste.
